(19) United States
(12) Patent Application Publication
(10) Pub. No.: US 2026/0208047 A1
(43) Pub. Date: Jul. 23, 2026

(54) SYSTEMS AND METHODS FOR CONTENT CREATION TOOLS AND CONTENT SOURCING

(71) Applicant: Sony Interactive Entertainment INC., Tokyo (JP)

(72) Inventors: Charles McCoy, San Diego, CA (US); True Xiong, San Diego, CA (US)

(73) Assignee: Sony Interactive Entertainment INC., Tokyo (JP)

(21) Appl. No.: 19/034,490

(22) Filed: Jan. 22, 2025

(51) Int. Cl. A63F 13/60; G06F 8/30

(52) U.S. Cl. CPC A63F 13/60; G06F 8/30

(57) ABSTRACT

System, process, and device configurations are provided for generative content crafting and game element source generation for an electronic game. Game element source generation can include creating the source for rendering artwork and systems and processes are provided for a tool to receive input from one or more users. The input, such as seed elements may be used to configure one or more layers and features of crafted elements. User annotations to seed inputs may also be detected to determine how to use the seed inputs. Processes and configurations allow for seed inputs to be applied to multiple layers and at one or more times of the generative operations. Iterations may be determined for elements and modified to allow for multiple users to develop a crafted element. Processes and systems may update source element iterations to include additional iterations and for merging of seed elements.

### CROSS-REFERENCE TO RELATED APPLICATION

This application is concurrently filed with U.S. patent application Ser. No. ______ titled SYSTEMS AND METHODS FOR GENERATIVE CONTENT CRAFTING AND GENERATIVE ARTIFICIAL INTELLIGENCE (AI) CONTENT CRAFTING, and U.S. patent application Ser. No. ______ titled SYSTEMS AND METHODS FOR EVALUATING AND MANAGING CRAFTED ELEMENT OF ELECTRONIC GAMES, the specifications of which are hereby expressly incorporated by reference in their entirety.

### FIELD

The present disclosure is directed to interactive entertainment and electronic video gaming, including generative operations, content creation and content source tools and processes, user interface control and control device configurations, and generative processes for the content crafting.

### BACKGROUND

Computer and console games have been developed in many styles for different gaming systems and platforms. Games and content are often directed to different forms of game play and even different styles of controllable elements. One popular gaming style includes building or developing elements within a game. In this game style, and many game applications, operations are deterministic and based on preprogrammed elements for game play. There is a desire for use of generative applications and programs in games. Many existing generative elements are only graphical or textual and thus, are not configured for use with electronic gaming. There is a desire to provide generation of game elements and functions for users. There is also need and a desire for generative processes and systems, and content creation tools.

### BRIEF SUMMARY OF THE EMBODIMENTS

Disclosed and described herein are systems, methods and configurations for generative content crafting and game element source generation. In one embodiment, a method includes receiving, by a device, at least one seed element, the at least one seed element received from a user as input for generation of a crafted element for an electronic game. The method includes controlling, by the device, a machine model to generate at least one source element iteration for the crafted element, wherein the source element iteration provides at least one output for rendering the crafted element of the electronic game. The method includes determining, by the device, at least one additional seed element for the crafted element, and controlling, by the device, a machine model to update the at least one source element iteration to include a second iteration. The method includes outputting, by the device, the crafted element to include the at least one source element.

In one embodiment, the seed element includes at least one of text, audio, graphical, video and user input, and wherein the seed element is received by the device and wherein the at least one seed element is received with an annotation providing an instruction for use of the at least one seed element for the crafted element.

In one embodiment, the seed element is input to first layer of a plurality of source code layers for rendering the crafted element.

In one embodiment, the iteration is generated based on a combination of seed elements from at least one user.

In one embodiment, the at least one additional seed element is determined to adjust at least one additional rendering level for the crafted element.

In one embodiment, controlling the machine model to update the at least one source element includes updating the source element iteration for at least one of a rendering structure, rendering appearance and rendering function using the second iteration.

In one embodiment, controlling the machine model to update the at least one source element includes tracking iterations and users associated with each iteration to the crafted element.

In one embodiment, controlling the machine model to update the at least one source element includes using a seed to update a plurality of rendering layers of the crafted element.

In one embodiment, output of the crafted element includes outputting source code for the crafted element, the source code configured for the electronic game and presentation of the crafted element during game play.

In one embodiment, controlling the machine model includes configuring the appearance of the crafted element followed by at least one of a structural and functional configuration of the crafted element.

Another embodiment is directed to a device configured for generative content crafting and game element source generation. The device includes an interface and memory storing executable instructions and a processor, coupled to the interface and memory. The processor is configured to receive at least one seed element, the at least one seed element received from a user as input for generation of a crafted element for an electronic game. The controller is also configured to control a machine model to generate at least one source element iteration for the crafted element, wherein the source element iteration provides at least one output for rendering the crafted element of the electronic game. The controller is also configured to determine at least one additional seed element for the crafted element, and control a machine model to update the at least one source element iteration to include a second iteration. The controller is also configured to output the crafted element to include the at least one source element.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1A is a graphical representation of generative content crafting and game element source generation according to one or more embodiments;

FIG. 1B is a graphical representation of generative content crafting and game element content layers according to one or more embodiments;

FIG. 1C is a graphical representation of generative content crafting and game element content features according to one or more embodiments;

FIG. 2 illustrates a process for generative content crafting and game element source generation according to one or more embodiments;

FIG. 3 illustrates a graphical representation of a system and device for generative content crafting and game element source generation according to one or more embodiments;

FIG. 4A illustrates a graphical representation of a system for content crafting according to one or more embodiments;

FIG. 4B illustrates a graphical representation of a process for content crafting according to one or more embodiments; and

FIG. 5 illustrates a graphical representation of generative content crafting training according to one or more embodiments.

### DETAILED DESCRIPTION OF THE EXEMPLARY EMBODIMENTS

### Overview and Terminology

One aspect of the disclosure is directed to generative content crafting and game element source generation for electronic games and processes and operations for generative crafting. Embodiments are directed to generative content creation tools and processes for generating and manipulating source content. Instead of merely rendering a final image of content to be presented for an electronic game, systems and methods provide operations for content creation that allow for multiple users, multiple seed elements and multiple iterations of crafted elements. Operations and systems may be performed by user devices, such as computing devices and server based devices to allow for generation of crafted elements. Generation of crafted elements may be part of electronic game development and may also be part of development of game features for an existing game. As reference herein, electronic games may relate to interactive media presented by gaming systems which may include consoles, processors or servers that generate game media. Embodiments may be performed to generated crafted elements that may be used as part of electronic games and for electronic game generation that may be presented by one or more network devices such as servers for providing, managing and hosting electronic games. Processes, system configurations and device configurations according to embodiments are provided to craft game elements, which can include one or more of a game tool (e.g., weapon, vehicle, armor, skin, etc.), game environment (e.g., background, landscape, mood lighting, location, etc.) game area, game character (e.g., player controlled, non-player controlled) and game element in general. Crafting as used herein may include generation of a game element and/or game feature based on user input. Crafting can include modifying an existing element of a game, generating an entirely new element of a game and using machine models for generation of game elements in response to a user input or instruction. Unlike generation of an image, processes and system configurations may be configured to generated game elements which require one or more of a visual representation, function within the game and game code to allow for use. Use of machine models may include use of artificial intelligence (AI) such as one or more of an AI engine, and generative AI content crafting.

Embodiments include operations and process to produce content from one or more seeds. Systems may receive and detect seed elements or seed content as input from a user. Systems may detect and/or review user annotations including instructions for use of seed elements. One or more forms of seed content may be detected an incorporated to generate crafted content. By way of example, a user may provide or identify image data including an image of an object and a user instruction to generate a game element (e.g., tool, weapon, character worn item, etc.) with an appearance of the provided image data. Similarly, a user may provide a text or spoken description of a game element to create. Seed elements may be detected as used as input, and processes described herein can utilize one or more seed elements.

Content crafting may utilize seeds as one factor and utilize electronic game data as a reference and/or constraint to generate crafted elements. In addition, seeds may be used based on user annotations, such that seeds may modify an existing source element. As such one or more seed elements may be limited or modified based on a user response. For example a user command to generate a color of an element may be limited based on the detected color patterns and pallet of the electronic game when game elements are generated. Embodiments include operations and process to train one or more models based on in game elements to determine elements (visual) and configuration (functionality) for use in electronic games. In addition to the appearance of an element crafted content may include generating and/or modifying game code of an element to allow for use in a game. Content crafting may apply to one or more elements of an electronic game including player controlled elements, non-player controlled elements and game environments. Embodiments may also be configured to generate one or more features of game areas (e.g., levels, worlds, race tracks, landing displays, menus, interactive controls, etc.).

Embodiments are not limited to creating tools. Content crafting and drafting by a machine model as discussed herein may be used for generating electronic elements for a variety of applications.

According to embodiments, generative content crafting and game element source generation includes using one or more machine learning models (ML). ML models used herein may be generated and used to for generative operation including generation of a character, game environment, game world and game elements in general. Machine learning operations may include artificial intelligence (AI) models configured to generate game elements.

According to embodiments, processes, device configurations and systems for generating generative content crafting may include receiving seed elements as user input for generation of crafted elements for an electronic game. A machine model may be controlled to generate at least one source element iteration for the crafted element. The source element may provide at least one output for rendering the crafted element in the electronic game and a plurality of iterations may be performed to generate visual representations, structural elements, and functions elements of each crafted element. According to embodiments, the iterations may be performed form a high level to a low level, meaning the iterations may first define some element, such as visual representation, wireframes or category of the crafted elements, additional iterations may be performed to define and/or characterize features of the crafted element. By determining structural elements, processes may determine movement elements of a crafted object. Functional features of the structural elements may also be defined. Embodiments may use templates to aide as a baseline or feature list required for the crafted elements to be incorporated into the electronic game. By way of example, a player controlled character or game element in general may include a human form, as such structural elements may be defined for body parts of the crafted element, such as body, head, legs, and arms. Functional features such as how the body parts move may be determined. According to embodiments, seed elements may be used to describe one or more features of the crafted elements. For example, seed elements may include a picture of a mouse with the user annotation to make the mouse muscular. Generative operations may generated a visual representation of the mouse in a muscular form. Processes and system configurations may perform one to more operations to generate a source element for presentation of the muscular mouse in an electronic game. The Source element may be developed over several iterations by one or more users defining one or more layers of the muscular mouse. The layers may specify characteristics of the mouse and include structural elements such a body parts, wire frame and/or representation units for rending the muscular mouse. Layers may be provided for characterizing and modifying functions of the muscular mouse. Functions may include movement patterns, movement ability of body parts and/or graphical elements associated with structural elements of the muscular mouse. The muscular mouse is an example, however, principles of the disclosure may be applied to generate over crafted elements and are not limited to this example. Users may provide seed elements and/or instructions to modify the crafted elements and operations discussed herein may generate and modify the source elements, which may be code that may be used by an electronic game. An electronic game may include one or more characters and one or more storyline elements. For example, the storyline may require a character to accumulate or locate items before challenging a game boss. Game details may be used as part of generating the features and characteristics of the crafted element.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

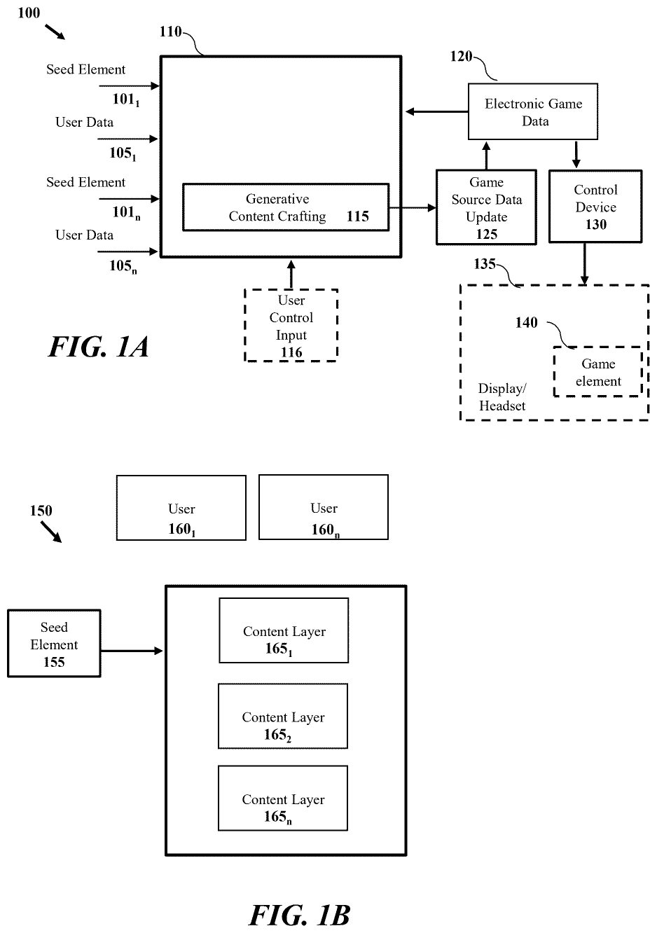

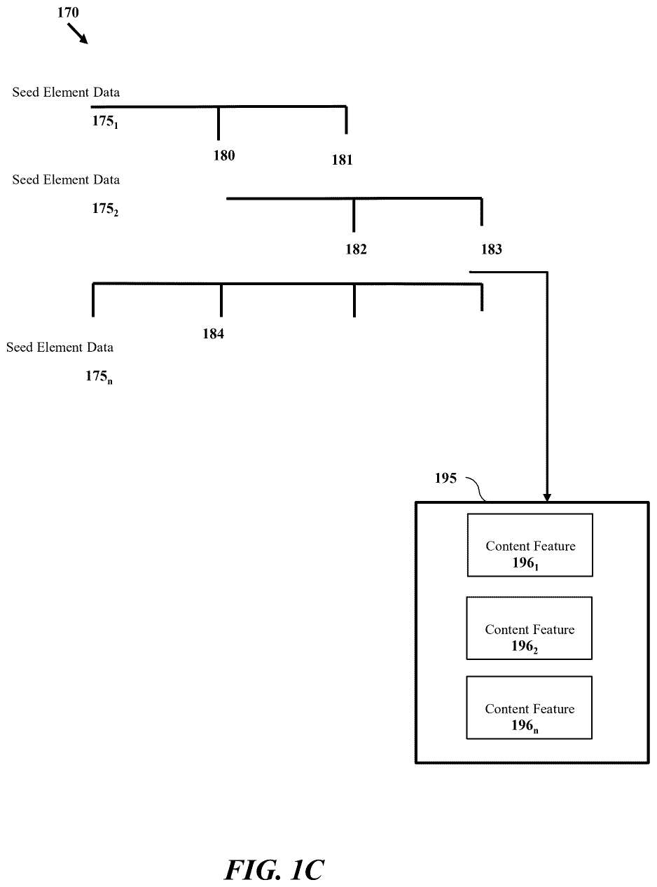

FIGS. 1A-1C are graphical representations of generative content crafting and game element source generation for an electronic game according to one or more embodiments. FIG. 1A illustrates system 100 for generative content crafting and may be a tool for generative operations (e.g., generative artificial intelligence (AI) operations, machine learning, etc.). According to embodiments, generative content crafting may be performed by at least one device for an electronic game and by one or more users. Content crafting may include generating one or more game elements, such as tools, characters, backgrounds, and game elements, for an electronic game and/or for use with one or more games. According to embodiments, content crafting may be based on one or more seed elements and user instructions. A seed element may include one or more items, such as game items user for crafting and/or uploading elements, in the form or images, test, words, and description provided by a user. Seed elements may be provided by a user and generation of a crafted element may be performed by one or more devices. System 100 illustrates operations for generation of a crafted element and operations that may be performed by a tool for generating crafted content. Processes described herein may include one or more operations performed by a machine model and/or artificial intelligence (AI) wherein machine processes generate one or more features of a game element based on user input, such as a seed input. Processes may generated the source code including one or more source element iterations that may result in the source code for a crafted element. FIG. 1B illustrates process 150 including one or more operations for generating layers and source element iteration of a crafted object. Unlike deterministic crafting of objects wherein a predefined combination of in-game elements may be used as input to unlock or present a game item, crafted elements may be generated to include elements and/or features which are not predefined in an electronic game. System 100 may utilize one or more operations of process 150 for generative content crafting. FIG. 1C illustrates process 170 including use of seed elements for one or more iterations of content crafting.

According to embodiments, system 100 may be configured to receive one or more seed elements, such as seed elements 101₁₋ₙ. System 100 may provide a content crafting tool that allows one or more used to generated crafted elements. Seed elements 101₁₋ₙ may be detected from users to define or provide input for one or more features of a crafted element. Seed elements 101₁₋ₙ may describe the element type (e.g., character, weapon, tool, environment, etc.) and/or features of the crafted element (e.g., cloak for a character, color of a weapon, etc.). User data 105₁₋ₙ may provide one or more of instructions and/or annotations from the user in what to create or modify. User data 105₁₋ₙ may start with a high level, such as create a character looking like this image as seed data. Another example may be to draw this image of a mouse as being muscular. Additional seed elements and user data may be received and detected by device 110, which may be a processor or computing device, to define lower levels of the crafted element. For example, user data may include the instruction to draw the character as having a red beard, increase the size of the axe, or slow the gait of the characters movement.

Content crafting may be based on based on seed elements 101₁₋ₙ and user data 105₁₋ₙ. Generative crafting operations 115 may be performed to generate the source code and data that may be used to allow for the crafted element to be used in an electronic game. Unlike generating only a visual representation, generative crafting can include modifying the source code and features such that visual aspects and functional aspects of the object are provided. According to embodiments, generative content crafting operations 115 may be based on electronic game data 120. Electronic game data may include data for one or more game titles to allow for generation of elements that fit with an electronic game time for both the appearance of objects, scale and functions. System 100 and device 110 may optionally receive user control input 116 providing feedback on generative outputs. User control input 116 may be a user interface for controlling and directing generative content crafting operations 115. Generative content crafting operations 115 may use one or more processes described herein to output game source data updates 125 including source data that may be used to for crafted elements in electronic games.

According to embodiments, a control device 130 (e.g., gaming console, interactive media player, etc.) may present electronic game data for gameplay including display output 135. The display output may include a crafted game element, such as game element 140 that may be created based on and/or using one or more of seed elements 101₁₋ₙ and user data 105₁₋ₙ. Game element 140 may be a generative element.

Systems and processes described herein may be configured to provide functions of system 100 to allow for a generative operations (e.g., AI) content creation tool with iterations and content sourcing. A variety of content crafting functions may be providing. For example, seed elements may be merged to generated crafted elements. For example, a seed element for a mouse and a seed element for a horse may be received as input and generative operations may select which features to utilize for a crafted element. In addition to the visual functions, processes for generating in game elements are provided including one or more layers, wireframes, movement patterns/element physics, and objects. In addition, an interactive generative tool is provided and configured to modify one or more aspects of the generated objects.

According to embodiments, system 100 may provide a generative content creation tool configured to provide source code generation. System 100 and embodiments may provide a tool for single and multiple users (e.g., artists, designers, developers, etc.).

System 100 may be configured as a tool use by a single user. Functions of the tool may include a generative AI content creation tool configured to create output that is the source for rendering artwork instead of just outputting the final rendering. Another function may be seeding generative AI content creation with one or more seed that is the source for rendering artwork instead of the seed just being a final rendering. Each element of the source can be annotated, such as to indicate not to change a layer or how the color palate should be changed. Also the annotation can include payment or exchange for use as well as security features (supporting encryptions, transmission protocols). Seeds that are the source for rendering artwork can be combined with seeds that are other media, such as written word or the final rendering of an artwork. Annotations can be applied to a seed as a whole, regardless of what type of seed it is. For example, a seed element that is a picture of a mouse can be annotated with the comment, “make more muscular looking.” The seeds can have expiration dates and have primary, secondary, tertiary, etc., and default seed. In some implementations, this will allow a digital artwork's elements such as characters, clothing, etc. to change without changing the overall theme.

Another function may be a generative AI content creation tool that allows an artist to focus on a particular level of detail, such as to change the clothing pixels of a character in a painting without changing other details. Another function may be an iterative process for generative AI content creation starting first at a high level and focusing on lower levels of details in subsequent iterations. By way of example, each iteration will generate a set of one or more outputs, each of which is the source for rendering artwork. In some implementations, more outputs can be requested each iteration if desired after looking through the set of outputs that have been output. Choosing one or more outputs to seed the next iteration. The seeds and/or portions of the seeds can be annotated to indicate the changes desired from the next iteration. Other seeds can be added to the seeds that are based on the output from the previous iteration. The outputs can be a set of sources for artwork that are variations on a theme, genre, style, historical era, and culture, or a combination of these. The portions of the seeds that are kept constant can cause some aspects to be consistent across the generated outputs, giving a consistency to the outputs.

System 100 may provide a tool can use templates to guide content creation. For example, there can be a template for generating a character that can be dropped into a game engine for use in a video game. Such a template would result in the creation of a character that has aspects that interact with the video game, such as having a quantity of hit-points or health. The model would contain information about how the shape of the character changes as it moves, such as bending its joints and leaning in the direction of movements. As another example, there can be a template to create a fictional story which will use traditional story structures. As another example, there can be a template to create a song styled in a particular genre of music, which could include details of traditional song structure for that genre of music. As another example, there can be a template for creating a tree. Such a template can include information about how trees have trunks, branching limbs, and leaves or needles. The template can contain information about optional features, such as flowers, nuts, seed pods, or fruit. The template can contain information on the extent of different variations in things such as sized, branching structure, bark texture, leaf growth patterns, and leaf shapes. Templates can be generated based on a training set of content, which can be provided explicitly or determined based on user interactions with generated content.

System 100 may be configured as a tool use by multiple users (e.g., artist collaboration). The tool may provide a generative AI content creation tool that uses source control to track the iterations and artist contributions in the collaboration to generate content. The tool allows rollback to a previous point in the process, and allows output from a previous iteration to be used as a seed multiple iterations later, such as to indicate that a portion of that output should be incorporated in the content generated for that iteration. System 100 may provide automated merging of non-conflicting changes from multiple artists working on the collaboration simultaneously. System 100 may also provide generative AI driven merging of conflicting changes. Create a set of outputs incorporating the different aspects of the changes in different combinations and proportions. The merging can take into account annotations to guide things such as what aspects of changes are most important and what the goal for the merged result is. These annotations can come from multiple contributors. Contributors can give feedback on one or more of the output possible merges to drive another iteration. Another iteration based on the merge can take into account the sources that were being merged, which may have annotations applied to them for the iteration.

Iterations of content creation can take seeds and/or annotations from multiple artists to drive the next round of output choices. The generative AI content creation tool that can discern the mood from the collaborated artwork to ensure it fits into the overall content theme (game, TV show, etc.). A generative AI content creation tool that tracks the changes and uses of a generated seed throughout the creative process across an aggregate of multiple collaborative projects. In some implementations, this process will boil the most used seed to collaborate giving it value to the contributors. In some cases, monetary value can be attached to the seed.

In some implementation, the collaboration can leverage a blockchain or immutable ledger record of the contributions and changes across many contributors to create a permanent record of the changes that were be made. This could be used for things such as to enforce a policy of not letting changes be rolled back or to ensure attribution for portions of the collaboration.

System 100 and processes described herein can utilize several control points. A generative AI content creation tool is configured to allow an artist to generate a set of one or more outputs that are restricted to content rating, e.g., Unrated, PG, TV-14, E, T, M, etc. so that the outputs are appropriate to the intended audience. The generative AI content creation tool is configured to allow an artist to generate a set of one or more outputs that are appropriate to an intended audience with visual impairment. To achieve this, the annotation can indicate the intended audience or type of impairment. The generative AI content creation tool is configured to include a litmus human test to discern the accuracy of an output against a range of criteria: intended audience, genre, style, historical era, and culture, or a combination of these, etc. The generative AI content creation tool is configured to produce a 3D model, which can then be rendered to produce a 2D image. This feature allows the artist to adjust crafted element features when creating the 2D rendering from the generated 3D model, such as the camera position, camera angle, light source positions, or positioning of characters and objects. In addition, more realistic 2D image productions may be generated, such as having an anatomically correct model of a human in the 3D model holding an object which would result in a 2D image showing the correct number and location of fingers on the human's hand.

System 100 may provide a user interface configure to allow the user to select output choices to select and/or reject for guiding the next iteration. The user interface allows the artist to easily visualize the breakdown of the source for each output choice that is generated, such as showing a series of images to represent layers and effects or showing an animation of a representation of a 3D model to approximate rotating the model or moving the camera to give the user a feel for the three dimensional arrangement of the elements in the model.

System 100 may be configured for voice commands to be used as an interface for a generative AI content creation tool, both to drive the user interface as well as to dictate text, such as seeds or annotations. A mobile application can be used to capture ideas on the go, such as dictating into a cellphone which causes the application to give quick feedback of what the generative AI envisions from what was said. Voice commands can be given to further guide the generation based on the whole batch of what was generated from the previous guidance. The app can allow indication of which outputs are being commented on and/or which outputs should be included and/or excluded from seeding the next iteration. A generative AI content creation tool can learn the preferences of the artist that is using the tool, such as preferred art style and color palate choices, and use those preferences to guide content creation to better appeal to the artist. Such preferences can be used to create a style that is unique to that artist using the generative AI content creation tool. System 100 is configured to allow the artist to zoom in on the details of particular elements and apply annotations to just the area they are zoomed in on, such as to zoom in on the hand of a person and indicate that the thumb should be obscured by the object the person is holding.

FIG. 1B is a graphical representation of generative content crafting and game element content layers according to one or more embodiments. According to embodiments, generative content crafting can include applying seed elements to one or more layers of an element to be generated. For each generated element, source code may be generated, the source code providing a collection of source elements that make up the crafted element. Modifications may be made to the source code element in iterations. Source code elements may include different layers, with layers providing different components or aspects of the crafted element. By way of example, two player controlled characters may be generated having similar layers for functions and structural elements. Layers for the visual appearance may be modified to distinguish the characters. According to embodiments, seed elements may be used to generate visual appearance and/or one or more other layers of the crafted elements. Seed elements may be used for structural, sizing, and functional characteristics of game elements. By way of example, when an image is generated for a person, structural layers may defined by generative operations for the body parts of the person and the functions layers may define the way the body parts move. Generative operations may use templates to assist. For rich character development, game elements may be configured and modified. Also, some elements, such as functional and structural elements may need to be defined to determine the visual elements to be rendered based on orientation and movement of the objects.

Process 150 illustrates receiving one or more seed elements, such as seed element 150. Seed elements may be received from one or more users, such as users 160₁₋ₙ. Generative operations may determine which content layers 165₁₋ₙ to apply seed element 155 to. As an example, content layer 165₁ may be for visual components, content layer 165₂ may be for structural characteristics and content layer 165ₙ may be for functional components of the crafted element. Seed element 155 may be applied to one or more of content layers 165₁₋ₙ.

Process 150 and configurations discussed herein may provide processes and configurations for one or more generative operations (e.g., generative AI) content creation tools. These generative operations and tools are configured to generate, use, and manipulate the source for content instead of just creating a final rendering of the content. Generative operations can work with the generated source to allow adjustments to the generated source to produce new content based on the content that was previously generated. For example, instead of producing a JPEG image an generative operations would produce a source file that contains layers for different items in the image, such as a layer for the background, a layer for a person in the image, a layer for an item being held by the person, and an item for a tree in the foreground. The generated source file could then be used to create a final rendering of a piece of content, could be modified before rendering, or could be used as an input to generative operations.

Embodiments allow for operations to build up a source for the content being created and manipulating different components of the source individually. Traditional generative AI content creation only produces a final rendering of the content that is generated. Embodiments allow for creating an image by creating different layers for different elements in the image as well as applying different components such as masking, gradients, color correction, and lighting effects. As another example, creating a model of a 3D object for a game would create a wire frame, texture mappings, skeleton for movement, library of movements, lighting effects, and effects for motion, such as hair or clothing. Generative operations can be used in the creation and manipulation of all types of digital media, such as for images, 3D models, music, movies, animation, literature, media, or advertising.

By creating a tool with generative operations that produce, use, and manipulate the source for content it allows the generative operations to produce content that is more useful to content creators and to be better integrated into a traditional content creation workflow. Generative operations can be used on an existing source for content to manipulate it or use it as the seed for creating new content.

As an example, a user could easily modify the source for an image to replace a hand they do not like the looks of with a hand they do like in a layer that just contains the hand not overlapping with anything. When the modified source is rendered, the tool layers the new hand over the background layer, without the user needing to do anything to manipulate the areas where the old or new hand intersects with the background. As another example, a user could easily resize an object being held in the source for an image and then render the modified source for the image to have the object larger in the rendering, without needing to worry about how the layers stack and obscure each other in the old or new versions. Masks may be used in the source for the content, such as to separate the portion of a hand that will be wrapped around an object being held from the portion of the hand that may be obscured by an object being held. The relative positions, sizes, and layering ordering of objects in a source for content can easily be manipulated independent of other aspects of the source for content.

Generative operations can take the source for content as a starting point and can create one or more new sources for content based on that input. Seeds, such as words or other content, can be used to guide the creation of new content based on the starting point. In some cases, new content is created by iterating over variations of a single component or group of components in the starting point source for content. For example, a user may be unhappy with the background in a source for content and use generative operations to generate a set of new content, each with a different background where the rest of the image remains the same. The user may seed generative operations with images or descriptions to guide the generative operations in choosing a background that would be more appealing to the user. As another example, a user may use generative operations to create versions of a source for content where multiple components are modified in the resulting sources for content. The user may specify to keep the face, hair, and pose the same in the source for content while allowing the other components to differ in the results. The user may specify what changes they wish made, such as to indicate that they wish the results to have a steampunk aesthetic. A source of content used as a starting point or seed for generative operations.

In some cases, generative operations can allow the use one or more components across a set of results to give a sense of consistency across a generated set of sources for content. Such a technique can also be used to create a set of content where the results are variations on a theme while still stylistically appearing to be part of the same set. Generative operations can allow a user to choose which components to keep the same and which can be modified, such as to specify that a certain color pallet be used so that the results fit in with other content.

In some cases, generative operations can learn from repeated use by a single user to learn from that user's workflow and styles of content they produce. A user can give feedback to generative operations as to which of the results it likes and what components of those results it wishes to modify, which the generative operations can use to learn what the user likes.

Generative operations can be used in the creation of content for games. Generative operations can be used for a game level design, which can consist of components that are a source for content for various elements of a game level. The source for content in a component of a level design can also consist of components that are a source for content for various elements of the source for content that they are components of. Generative operations s can be used to create in-game objects where each one is a variation on a theme but is still identifiable as to what object it is even though it is unique. For example, generative operations can be used to create a set of in-game objects that are all recognizable as a specific species of tree, but each tree object is unique.

Generative operations can be used in a video game, or other program with customizable avatars, to allow a player to customize their character. Generative operations can allow a user to manipulate particular components, such as the wireframe for the face, while leaving other components unchanged. Such a use will allow the creation of characters or avatars that are unique. In some cases, the user can specify seeds, such as giving a written description of how they want their character to look, or specifying one or more images or objects to use as seeds.

FIG. 1C is a graphical representation of generative content crafting and game element content features according to one or more embodiments. Embodiments allow for different users (e.g., users 160₁₋ₙ) to modify and update a crafted element. Each modification may be a source element iteration for the crafted element. Process 170 may be performed using seed element data 175₁₋ₙ. According to embodiments, seed element data 175₁₋ₙ may be applied to multiple layers and during multiple points of time during the development of the crafted element. Process 170 illustrates seed element 1175₁ being applied at source element iterations 180 and 181. Seed element 175₂ being applied at source element iterations 182 and 183 and seed element 175ₙ applied at source element iteration 184. Source element iterations 180 and 184, for example, may be iterations performed for the same layer or feature of a crafted element. Generative operations may merge and/or modify multiple user inputs, such as a first user input and a second user input to define a feature for a crafted element.

Process 170 may output crafted element 195 including a plurality of features, such as content features 196₁₋ₙ. Content features 196₁₋ₙ may provide elements determined for a crafted element including but not limited to visual, structural and functional components of the crafted element.

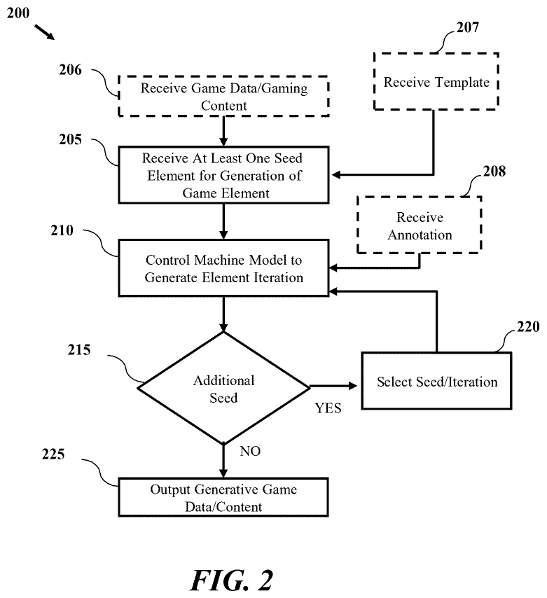

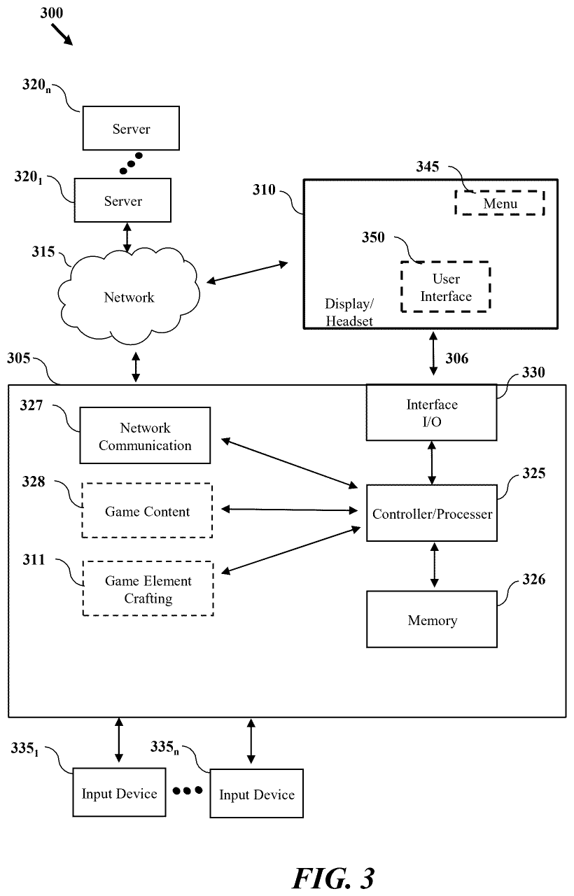

FIG. 2 illustrates a process for generative content crafting and game element source generation according to one or more embodiments. Process 200 may be configured to generate one or more elements or configurations for electronic games, including configuration of one or more existing elements of game elements and generating one or more new game elements and game areas. Process 200 may be perform to generate source code based on source element iterations for crafted elements. Process 200 may be performed by a device, such as device 305 and/or controller/processor 325 of FIG. 3, for generative content crafting.

Process 200 may be initiated by a device (e.g., device 305) receiving at least one seed element (e.g., seed element 101₁₋ₙ) at block 205. Seeds elements may be received at block 205 for generation of a game element, such as a crafted element. At block 205, process 200 may include receiving user instructions (e.g., user data 105₁₋ₙ) for generation of a crafted element and modifications and generation of crafted element source code game element. User instructions may be annotations or instructions for seed elements. According to embodiments, receiving at least one seed element may include receiving the seed element from a user as input for generation of a crafted element for an electronic game. Seed elements may be received including at least one of text, audio, graphical, video and user input. The seed elements may be received by a device such that each seed element is received with an annotation providing an instruction for use of the at least one seed element for the crafted element. Seed elements may be inputs to a content generation tool and may specify the layers or elements to be generated. The seed element received at block 205 may be input to first layer of a plurality of source code layers for rendering a crafted element.

Process 200 may optionally include receiving game data/gaming content at block 206. Gaming data may include game elements, such as tools, weapons, characters and gameplay data including environment types, themes and colors user. Different games may include different gameplay styles and types of elements that fit within the game. For example a racing game may be mobiles. Game data may be used to assist with content crafting such that the elements are created fit within the game and the game design. With reference to the example of a racing game, generation of a boat could be restricted. Generation of a vehicle based on a user seed element may take one or more characteristics of the user seed element to generate a vehicle for the game. By way of further example, a user seed element including a car type, color and vehicle feature may result in one or more of these elements being integrated into a new vehicle with the same (or similar) car type, color and/or vehicle feature. Seed elements can be a text or audio description of the tool to be created and function of the tool. Embodiments including training a model based on in game elements to determine elements (visual) and configuration (functionality) for use in game. Content production may be performed to fit one or more aesthetics and game title elements. Crafted elements may be for more than just tools, including but not limited to modifying the appearance of a player controlled character, background and/or gaming element. Crafted elements may be modification of game elements of an electronic game to provide modification of character appearance, shape, and size.

Process 200 may be performed on electronic games (e.g., video games, interactive games, etc.). Electronic games may include one or more player controlled elements, a visual display or one or more levels or areas, and the ability of the user to control the character relative to one or more levels and areas. Electronic games may also include non-player elements such as non-player characters or playable game areas (e.g., routes), non-playable game areas, and various forms of displays.

Process 200 may optionally include receiving a template at block 207 including one or more data parameters and code plugins that allow for generating crafter elements to comport with processing of a game. Display games may require game elements to include a visual appearance, size and/or zones of interaction with other game elements. A machine model may be controlled to use at least one game element template and the game element template may be selected based on the seed element. The game element template may include at least one field description, each field description of the template providing a characteristics for generating the crafted element. Received templates may be used by process 200 to configured characteristic of a received seed element into code that may be used as part of the electronic game. Templates received may include one or more fields and data constraints to allow elements to be generated. Templates may be for tools (e.g., elements a character can use within the game), characters, character features and environment including background.

At block 210, generative content crafting may be based on one or more received templates to create particular forms of content, such as a hat, outfit, decoration, trophy, sword, armor, creature, music, sound effect, blessing, training, or potion. Such a template would provide a framework to ensure that the generated object can be used for a particular purpose, such as to allow the item to be equipped in a game. Different crafted items can be usable for different purposes by an electronic game. In some cases, one or more templates for generated items can be derived from the seeds used to initiate the crafting.

At 210, process 200 includes controlling a machine model to generate at least one source element iteration for the crafted element. The source element iteration provides at least one output for rendering the crafted element of the electronic game. Crafted elements may be generated based on a plurality or source element iterations. Iterations may be generated based on a combination of seed elements from at least one user.

According to embodiments, process 200 may optionally include receiving an annotation at block 208. User annotations may provide instructions on how seed elements are to be applied. Generative operations may use the seed element and the user annotations to then modify one or more of visual and source code of a crafted element.

At decision block 215, process 200 may determine at least one additional seed element for the crafted element. When an additional seed elements are detected or present (“YES” path of decision block 215), process 200 may select a seed iteration to modify at block 220 and perform generative operations at block 210. At least one additional seed element is determined to adjust at least one additional rendering level for the crafted element. For example the machine model may be controlled to update the at least one source element iteration to include a second iteration. Controlling the machine model to update the at least one source element can include updating the source element iteration for at least one of a rendering structure, rendering appearance and rendering function using the second iteration. Controlling the machine model to update the at least one source element can includes tracking iterations and users associated with each iteration to the crafted element. Controlling the machine model can include configuring the appearance of the crafted element followed by at least one of a structural and functional configuration of the crafted element. Controlling the machine model to update the at least one source element can include using a seed to update a plurality of rendering layers of the crafted element.

When an additional seed elements are not detected or present (“NO” path of decision block 215), process 200 may select a seed iteration to modify at block 220 and output generative game data/content at block 225. Output of the crafted element includes outputting source code for the crafted element. The source code may be configured for the electronic game and presentation of the crafted element during game play.

Process 200 may be performed on electronic games (e.g., video games, interactive games, etc.). Electronic games may include one or more player controlled elements, a visual display or one or more levels or areas, and the ability of the user to control the character relative to one or more levels and areas. Electronic games may also include non-player elements such as non-player characters or playable game areas (e.g., routes), non-playable game areas, and various forms of displays.

FIG. 3 illustrates a graphical representation of a system and device for generative content crafting and game element source generation according to one or more embodiments.

According to embodiments, generative content crafting and game element source generation may be performed and used by a device or a system. Game element source generation may be performed for generation of source data for a network gaming system. A system can include one or more components and devices. FIG. 3 illustrates system 300 according to embodiments which can include device 305 and may be configured to output electronic game data including at least one crafted element. Device 305 may be one or more of a gaming console, computing device and electronic device in general configured to output gaming content 306 to display 310 and may include output of generated game worlds and electronic game content. With respect to gaming content, device 305 may be configured to output data for presentation by a display, or visual output device in general, including graphics (2D and 3D), sound and data. Device 305 may also be configured to output non-gaming content, such as video content, visual content, audio content, etc. Embodiments describe generative content crafting for electronic games and gaming, however it should be appreciated that the principles of the disclosure may be applied to other forms of media and non-gaming content. As such, device 305 and system 300 may be configured for generative operations that may be applied for one or more applications.

According to embodiments, device 305 is configured to output data 306 and/or content to display 310. According to embodiments, display 310 may be separate from or part of device 305. Device 305 may be configured for network communication by way of network 315 with one or more servers 320₁₋ₙ. Network communication can include one or more network communication type (e.g., Local Area Network (LAN), Metropolitan Area Network (MAN), Wide Area Network (WAN), Wireless, Inter Network (Internet). Device 305 may be configured to receive one or more of user data, game data and video data from servers 320₁₋ₙ. Servers 320₁₋ₙ may be configured to store one or more of user data, game data and generative data.

FIG. 3 depicts a device configuration according to embodiments. Device 305 may relate to a console, media device, and/or handheld device. Device 305 may be configured for generative content crafting for an electronic game. Device 305 may be configured to perform one or more processes described herein for generative content crafting. According to embodiments, device 305 includes controller 325, and memory 326. Device 305 may also include network communication module 327. Device 305 may also optionally include game content 328. Device 305 may optionally include a display 311 and/or may interoperate with display 310.

Controller 325 may relate to a processor or control device configured to execute one or more operations (e.g., executable instructions) stored in memory 326, such as processes for game world generation and game world population. Controller 305 may be coupled to memory 326, network communication module 327, and interface (I/O) 330. Memory 326 may be non-transitory memory configured to provide data storage and working memory operations for device 305. Memory 326 may be configured to store computer readable instructions for execution by controller 325 for one or more processes described herein. Network communication module 327 may be a communications module configured to receive and transmit network communication data.

According to embodiments, device 305 may be configured to receive at least one seed element and a user instruction for generation of a game element, wherein the seed element includes a user description of a game element to be generated. Device 305 may be configured to control a machine model for game element generation using the at least one seed element, wherein the machine model is controlled to generate a crafted game element. Device 305 may be configured to output the crafted game element for the electronic game.

According to embodiments, device 305 may be configured to receiving at least one seed element from a user as input for generation of a crafted element for an electronic game. Device 305 may control a machine model to generate at least one source element iteration for the crafted element. The source element iteration can provide at least one output for rendering the crafted element of the electronic game. Device 305 can determine at least one additional seed element for the crafted element and control a machine model to update the at least one source element iteration to include a second iteration. Device 305 can output the crafted element to include the at least one source element.

Device 305 may be configured to receive gaming media (e.g., card, cartridge, disk, code, data, etc.) and output visual and audio content of the gaming media to display 310. Device 305 may be configured to receive data from one or more of servers 320₁₋ₙ to present and output game content 328, which may be stored in memory 326. For network games, device 305 may receive game data from a network source, such as servers 320₁₋ₙ, and may be configured to generate gaming music for the game data. Device 305 may similarly be configured to receive video content in general, including non-network game data, and output video content.

Device 305 may be configured to receive input from one or more peripheral devices, such as input devices 335₁₋ₙ. Input devices 335₁₋ₙ may be controllers or input devices in general configured to provide controls for device 305 and game control.

System 300 may include display 310 for output of visual and audio of an electronic game and/or output of device 305. According to embodiments, display 310 may display control elements of device 305, such as optional menu 350, which may be used to interface with device 305. Display 310 may output user interface 350 received from device 305. Device 300 may utilize one or more operations of processes described herein. It should also be appreciated that system 300 and its components may be configured to perform operations of device 305.

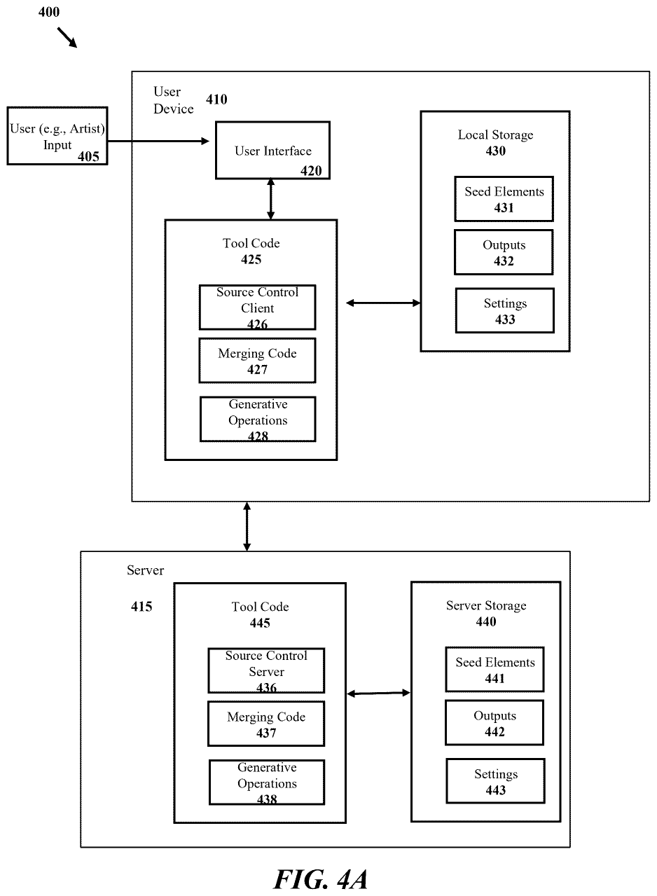

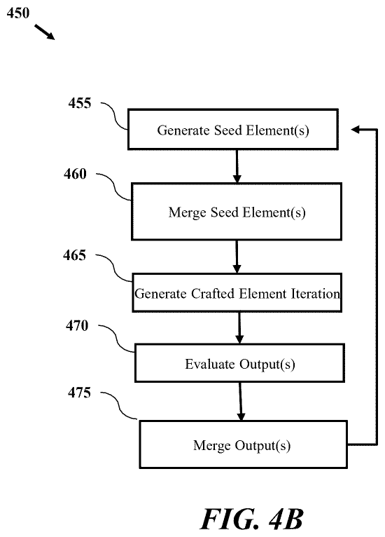

FIG. 4A illustrates a graphical representation of a system for content crafting according to one or more embodiments. According to embodiments, a generative content creation tool is provided. FIG. 4A illustrates system 400 configured to receive user (e.g., artist, designer, etc.) input for generative content crafting. System 400 includes user device 410 which may be a computing device or workstation and server 415 which may be a network device including processing capabilities. According to embodiments, user's may provide seed elements (e.g., input) and controls for generation of elements and to modify one or more layers of generated elements. User device 410 include user interface 420 which may be configured to receive user input 405. Tool code 425 may perform one or more generative operations for content creation and crafted content modification. Local storage 430 of user device 410 may store crafted elements and information for content crafting.

According to an example, FIG. 4A illustrates a block diagram of the components of a representative implementation of a generative tool when used by a single artist and single device. The implementation may relate to one or more users using the system to create crafted elements and artwork. User 405 interacts with the user interface 420 running on user device 410. User device 410 can be any type of computing device that the artist can interact with, such as a laptop computer or mobile device. User interface 420 interacts with the tool code 425 which tracks the seeds for driving the generative AI, runs the generative AI, and tracks the outputs of the generative AI. In some implementations, the tool code 425 uses source control to track the iterations through the generative AI, the seeds and outputs from those changes, and the changes that are made through the process. In the implementation shown, the tool code 425 running on user device 410 uses source control client 426, which manages seeds 431 and outputs 432 stored in local storage 430. The source control client 426 also manages the synchronization of the seeds 431 and outputs 432 in local storage 430 with the seeds 431 and outputs 432 for the project that are stored in server storage 415 by communicating with a source control server 436 running as part of the tool code 445 on a server 415.

In some implementations, the tool does not use source control to manage the seeds and outputs, in which case the tool code 425 takes care of managing the storage of the seeds 431 and outputs 432 in local storage 430.

In some cases, source control can allow a first user 405 to lock an aspect of the creation to prevent conflicting changes to be made to that aspect while a second artist works on the creation.

Tracking the changes through activity for iterations of the tool, both for a single artist 405 and the collaboration between multiple artists, has benefits for the process of using the tool. For example, in iterations where the tool uses source control to track the activity of each iteration of using the tool it allows rewinding to a previous iteration or bringing back elements from previous seeds and outputs from previous iterations to use again. Source code has additional advantages when coordinating change made by multiple artists, as it can allow others to see the contributions made by each artist and use elements of those contributions in future iterations.

In some implementations, a first user 405 uses the tool on a first user device 410 and a second user 405 uses the tool on a second user device 410 to collaborate on the same project. Coordination of the work they are doing is done through server 415. In some cases, one of the user devices 410 may act as server 415 to coordinate changes made on multiple user devices. More than two artists 405 and user devices 410 are possible.

Merging code 427 running on user device 410 and/or merging code 437 running on server 415 can be used to merge changes when changes made by artist 405 conflict with what is stored for the project in server storage 440, which could have been made the artist 405 or by a second artist 405 that pushed their changes to the server. In some implementations, merging code 437 running on server 415 is used instead of running merging code 427 running on user device 410. The merging code produces a set of outputs, which may contain one or more outputs, based on the sources to be merged. In some cases, the merge is performed automatically based on analysis of the sources to be merged. In some cases, the merging code is guided by feedback by one or more artist 405. In some cases, the merging code makes uses of a generative AI engine when performing the merge.

Some merges are easy and straightforward, such as when different elements are modified. For more complex merges, the merging codes may create another iteration for the merge where it creates seeds based on all versions that need to be merged and uses the generative AI engine to create a set of outputs. The seeds chosen for the iteration for the merge may contain multiple seeds with conflicting changes or aspects. The artists involved can go through the set of outputs the same as they would for the outputs from an iteration that was initiated by artist feedback to create seeds for the next iteration. Seeds from the merge iteration can be selected to be included as seeds for the next iteration, which would be useful in the case where an artist desires to preserve a particular aspect that was included in the merge, in which case the artist may annotate that aspect as something they wish to preserve in the seeds for the next iteration to ensure that it will be included in the outputs unmodified.

In an example, a first artist 405 executed an iteration in a project and came up with a first set of new outputs 432 while a second artist 405 executed an iteration in the project and came up with a second set of new outputs 432. When merging, the merging code would need to combine multiple unique aspects from each set of outputs to create the merged results. The merging code can present conflicts to one or more artist 405 to have the artist choose between conflicting aspects.

In some implementations, the merging code would pick one version of an aspect to create an output from between multiple conflicting aspects. The merging code can create multiple outputs for different combinations of choices between conflicting aspects. In some implementations, the merging code can use artificial intelligence to make a set of choices for each output that are judged to create a result that goes together, such as to have a common theme or coloration.

Local storage 430 stores data other than seeds 431 and outputs 432 such as settings 433 that contains things such as information about different projects and iterations, user preferences, and how to connect with server 415. Server storage 440 stores data other than seeds 441 and outputs 442 such as settings 443 that contains such things as information on projects and iterations and security settings.

In some implementations, the whole system runs on a single user device 410, in which case the tool code 425 does all the work for the tool and does not communicate with tool code 445 running on server 415. In some implementations, artist 405 can use the tool on a first user device 410, which may be a mobile device, where the tool code 425 running on the first user device 410 communicates with tool code 445 running on a second user device 410, which may be a laptop computer, which acts as the server to first user device 410.

In some implementations, user device 420 is presented to artist 405 through a web browser running on user device 410. In such an implementation, tool code 425 may be in the form of a web application that is downloaded by the web browser, which can be comprised of things such as HTML, CSS, images, and JavaScript.

To create outputs based on seeds, the tool code uses a generative AI engine. In some implementations, the generative AI engine 428 runs on user device 420 and tool code 445 on user device 410 sends seeds to the generative AI engine 428 to generate a set of outputs. In some implementations, the generative AI engine 438 runs on server 415 and the tool code 445 running on user device 410 communicates with tool code 445 running on server 415 to have seeds run through generative AI engine 438 on the server to generate a set of outputs. Having the generative AI engine run on server 415 instead of user device 410 allows for using a model that is too large to fit on user device 410, which can be useful if user device 410 is a mobile device or generative AI engine 438 uses a particularly large model.

FIG. 4B illustrates a graphical representation of a process for content crafting according to one or more embodiments. Process 450 represents operations for representative iterative use of the tool. The use of the tool starts with generating seeds at block 455 to drive the generative AI generation of content. The initial use of the tool may start with creating a set of seeds based on a high-level vision of the content to be created, which may contain text descriptions, images, or other media. In some cases, the set of seeds created at block 455 may include elements that are annotated to indicate a general look and feel, style, or emotion to be evoked by the generated artwork. For example, the seeds for generating a forest village may include images of beautiful peaceful forests with such annotations to trigger creation of an inviting utopian village, or may include images of dark foreboding forests with such annotations to trigger the creation of a creepy dystopian village. Seeds created at block 455 may include annotations indicating that different seeds are to be used for different aspects of the creation. For example, an image of mountains may be annotated to be an example for the background, while an image of a dilapidated barn may be annotated to be an example of a building that should be the focus in the foreground. Seeds created at block 455 may include seeds for must have aspects of the final creation and nice to have aspects of the final creation. In such a case, at block 465 would make a best effort to ensure that all of the must have seeds are fulfilled in each generated output while including as many nice to have aspects in the outputs.

When contributions are made by multiple artists or through multiple devices, process 450 includes operations to merge seeds at block 460 before running generative operations at block 465 to create a set of outputs. Once a set of one or more outputs is generated, the user 405 will evaluate outputs at block 470 to determine which outputs contain desirable attributes and what from each output is desirable to propagate through the next iteration. Attributes that should be modified in the next iteration, along with how they should be modified, can be identified at block 470.

In some implementations, once an artist has evaluated outputs at block 470, the evaluation of outputs is merged with evaluation of other outputs, another artist's evaluation of the outputs, or another artist's evaluation of another set of outputs in the merge outputs at block 475. For example, a first artist goes through one or more iterations to establish an overall layout of the characters and other objects in the desired creation while a second artist goes through one or more iterations to get the hair for the characters to look the way they want it to look. After the first artist gets the layout of objects the way they wish, they can annotate the output or outputs with the layouts that they desire with annotations indicating to keep the layout unchanged, while the second artist annotates the hair for the characters in the output or outputs that have the hair they desire as aspect to keep unchanged. The merge seeds operation at block 460 would then create a set of seeds from both artists that have seeds to keep the layout the way the first artist desires while keeping the hair the way the second artist desires.

In an example, the merge seeds operation at block 460 combines seeds from an artist using the tool to specify aspects of an artwork they wish to create, along with brainstorming ideas that the artist gathered through the tool running on a mobile device or gathered through other means to create a set of seed to drive the first iteration of the generative AI at block 465.

The generative AI uses the set of seeds that it is given to create a set of one or more outputs. Each output would be a source for rendering the desired artwork, consisting of components, such as image layers, 3D model objects, or musical tracks, that can be combined to create a final rendering of an artwork.

In some cases, generate seeds at block 455 may include mutually exclusive seeds, such as an image of a mouse by a first artist and an image of a unicorn by a second artist, as an example. In such a case the generative operations at block 465 may create some outputs that are based on the first conflicting seed and some outputs that are based on the second conflicting seed. In some cases the generative operations at block 465 may include some outputs that attempt to blend the conflicting seeds into a new creation.

After the generative operations at block 465 may has generated a set of outputs, the set of outputs an artist will evaluate the outputs at block 470 to determine which outputs have aspects that are desirable and which outputs can be ignored. The outputs that have aspects that are desirable can be annotated by the artist to indicate the desirable aspects of the output that should be kept the same for the next iteration or should be used as the basis for the next iteration. If an aspect is to be used as the basis for the next iteration, it can be annotated with an indication as to what should be modified from the aspect and what should be kept the same for the aspect, such as keep the pose for the mouse but make the mouse more muscular. If an output is identified as being close enough to what is desired, then the iterations for that project in the tool can end, with the indicated output being the output for the project.

In some implementations, the evaluation of outputs involves an artist making manual edits to an output to use as a seed in the generate seeds at block 455 for the next iteration. In some implementations, the tool will provide the user interface to make the changes to an output. In some cases, an external application is used to make changes to an output. For example, artist may manually edit an output that contains a character to add a tattoo to their arm. Artist may then annotate the tattoo they added to indicate that the tattoo should be extended to cover both arms of the character.

In some implementations, the evaluation of outputs can include modification of outputs or annotations of changes to make to outputs for changes such as reordering layers or changing relative sizes, positions, orientations, or performing geometric transformations.

In some cases, evaluate outputs at block 470 may include making modifications to one or more outputs or adding annotations of changes to make to one or more annotations for changing output aspects such as the coloring—such as brighter, darker, warmer, or cooler—, texture—such as smoother, shinier, more jagged, or furrier—, or reflectiveness—Such as more reflective, or more diffuse reflections. There are many elements of an output that can be modified or annotated in the evaluate outputs at block 470. For example, if the output is a 2D source for an image, then artist can modify or annotate aspects such as the images or vector graphics in different layers, the ordering of layers, the relative sizes of different layers, masking, color pallets or filtering, lighting, or textures that are used. As another example, if the output is a 3D model, then artist can modify or annotate aspects such as the shape of 3D model objects, the skeletons that control possible movement of the 3D models, movement sequences—like walking, running, or squatting—, lighting, backgrounds, textures, audio generated—such as the squeaking of a hinge when it is moved, or game mechanics and interactions. As another example, if the output is a model for generating music, then the artist 101 can modify or annotate aspects such as the tempo, key, octave, melody, instrumentation, percussion, vocals, Foley sounds, mix, or effects.

In some cases, the evaluate outputs at block 470 may include swapping out one element for another or adding annotations to swap out one element for another. For example, artist may like an output that shows a beach scene, except that the beach scene shows a canoe in the reflections of the sunset off of the shore and artist thinks it would look better with the sailboat from an output from a previous iteration, so artist makes the change or adds annotations to have the change made.

In some cases, the evaluate outputs operations at block 470 may inspire artist to want to go in a different direction or include something new. In such a case, the artist could then include new seeds for the generate seeds operations at block 455 for the next iteration that are unrelated to the outputs generated by the generative AI operations at block 465.

In the evaluate outputs operations at block 470, if an aspect of an output resonates with artist, the artist may add an annotation to that aspect of the output to have that aspect be included unmodified in the next iteration in the generative operations at block 465. Such a technique can be used to preserve aspects that are desirable when they are created during the generative operations at block 465.

In an example, an artist may modify the instruments that are used for each track in a musical output that was generated in the generative operations at block 465 during the evaluate outputs operations at block 470. Many other aspects of a musical output may be manipulated, such as tempo, key, melody, vocals, equalization, Foley sounds, or effects like reverb, pitch shift, or echo. In another example, artist may add ambient sounds or sound effects to a 3D model that was generated in the generative operations at block 465 during the evaluate outputs operations at block 470 to make the 3D model have more impact when included in a game. Such sound effects can be associated with actions for a 3D model, such as adding a creaking sound to a door 3D model that is triggered when the door opens.

In some implementations, there will be a merge outputs operations at block 475 after the evaluate outputs operations at block 470. This can be done to merge outputs created by multiple artists, or to merge outputs created by different iterations, such as to include an output from a previous iteration in the seeds for the next iteration. For example, the evaluate outputs at block 470 may allow the artist to indicate outputs from a previous iteration, such as a rendering of a squirrel, to be included in the generate seeds at block 455 for the next iteration, which may include annotations from the artist, such as to indicate that the squirrel should be positioned on a horse from an output from the current iteration. The merge outputs at block 475 can also be done to merge outputs created from external sources like a manually edited output, additional text, or additional media.

In some cases, an output for an object, such as a game character, may include an AI model for the object's interactions with game players.

In some implementations, the merge outputs at block 475 will allow a first artist to see changes made by a second artist. In some cases, the first artist may be allowed to approve or reject changes made by the second artist. In some cases, the first artist may be allowed to make changes to the changes made by the second artist. The feedback from the first artist on the changes made by the second artist may be used to generate seeds at block 455 for the next iteration of the tool. In some implementations, the first artist may create new seeds based on additions or changes made by the second artist. Such new seed creation may be facilitated by the tool to encourage work done by a second artist to inspire work from a first artist 101.

In some cases, the first iteration of the tool will create a set of outputs for the high-level concept of the artwork to produce, with additional iterations narrowing the focus of what details are being worked on for that iteration. The additional iterations may branch into separate iterations for different lower-level details, such as an iteration for hair, an iteration for clothing, an iteration for the background landscape, and an iteration for the pose of the characters. These branched iterations can be combined in a merge outputs at block 475, which may generate seeds at block 455 for an additional iteration that combines the desired aspects of the outputs that are merged.

In some implementations, when an artist 1n the evaluate outputs at block 407 determines that an output is ready for deployment, the tool can facilitate deployment of the output such as creating a final rendering of the output, exporting the rendering into a particular format, creation of an NFT or other token for the output, publication of the output, registry of ownership of the output, creation of a certificate of authenticity, or watermarking of the output.

In some cases, the annotations added to outputs in the evaluate outputs at block 470 may be in a form other than media used in the output, such as to add words an output that is the source for generating a still image, adding a still image to an output that is the source for creating a video clip, or adding audio to output that is the source for a 3D model. For example, if an output is the source for a 3D model of a bard character, that output could be annotated with one or more audio files of examples of music the bard could sing. Running that annotated output through another iteration could result in an output that is the source for a 3D rendering of a bard character with meta-data to allow that character to be incorporated into a video game such that the character would sing music in the style of the audio files the previous output was annotated with. Such a tool can allow a first artist to focus on a first aspect of a collaboration, such as the overall structure, and a second artist to focus on a second aspect of a collaboration, such as the landscape in the background. Additional artists may contribute the collaboration, focusing on different aspects. In some cases, a first artist and a second artist may work closely together on a collaboration, each contributing seeds to each iteration and using the merge seeds at block 460 to include seeds from both artists in each iteration.

In some cases, the tool running on a mobile user device may provide aspects of the user interface that facilitates collection of brainstorming ideas from artist such that they can be easily incorporated in the generate seeds at block 455 of using the tool. For example, the user interface may provide a way to take an image and/or dictate text to be saved as the basis of seeds for an iteration. In some cases, source control server can coordinate brainstorming collected between multiple artists using multiple user devices to allow a first artist to see brainstorming generated by a second artist. The first artist may be inspired by the brainstorming generated by the second artist. The first artist may annotate or otherwise give feedback, such as voting on brainstorming generated by the second artist.

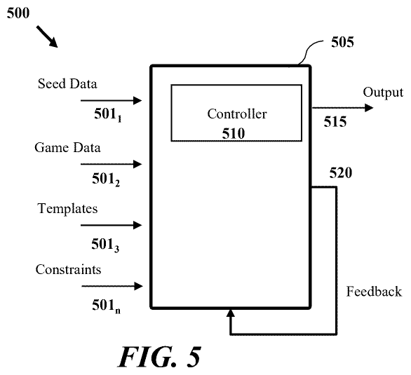

In some cases, AI can be used to correct when things overlap incorrectly, are out of scale, or have unnatural reflections or shadows. In some cases, the AI is smart enough to detect such cases and correct them automatically. In some cases, artist annotates outputs with changes to make in the evaluate outputs at block 470 step to cause the generate AI operations at block 465 to make the changes in the next iteration. According to embodiments, generative content crafting and content source tools may be performed using one or more references and models. Contextual information for objects, object function and object appearance may be determined based on a training process. Similarly, game function, use of the crafted game element and decision making for content source data may be based on a training process. FIG. 5 illustrates training process 500 which can include receiving training input 501₁₋ₙ by a device 505 including a controller 510. According to embodiments, controller 510 may receive a plurality of gameplay videos and/or electronic game data for an electronic game as training input 501₁₋ₙ. In embodiments, training input 501₁₋ₙ may relate to rendered video data for a particular electronic game and one or more additional electronic games. Training input 501₁₋ₙ can include one or more references for game elements, user feedback and operability of an electronic game with crafted content. Training input 501₁₋ₙ may include game engine data for one or more electronic games. By way of example, training input 501₁₋ₙ can include seed data 501₁, game data 501₂, templates 501₃, and constraints 501ₙ. Based on the training in process 500, controller 510 may generate output 515. Output 515 may include one or more determined objects, game areas, game storylines, electronic game modifications, new characters, character speech and elements for populating game worlds. According to embodiments, controller 510 may be configured to generate output 515 based on a recursive loop including training and feedback. Feedback loop 520 may provide information such as ratings and accuracy for output 515.

According to embodiments, training process 500 and controller 510 may be configured to use one or more learning models (e.g., artificial intelligence, iterative models, etc.) to recognize objects and elements in an electronic game. Training process 500 and controller 510 may use one or more libraries of common electronic game objects, including object images and object descriptions.

According to embodiments, process 500 ma y be used for training and generative operations. Generative operations can be trained with content that is curated to be a good fit for the game environment. For example, for a crafting system in an adventure game set in a medieval setting would not be trained on content depicting modern objects such as telephones and cars that would be out of place in such a game setting. In some cases, generative operations may be trained with the game artwork and predefined objects. Using game objects may provide a basis for creations to modify layers and define layers of objects. This can also result in the generative AI creating content that has functionality for merging seed elements from one or more users.

In some cases, the generative operations is trained with a library of artwork that is similar to the artwork used in the game but is not artwork that is directly used in the game. Such a library can have a similar art style, setting, or set of fantasy creatures depicted in it. This can give the generative operations a bigger range of styles and forms to use in its creation, leading to greater variety, while still creating content that seems like it fits in the game environment.

While this disclosure has been particularly shown and described with references to exemplary embodiments thereof, it will be understood by those skilled in the art that various changes in form and details may be made therein without departing from the scope of the claimed embodiments.

What is claimed is:

1. A method for generative content crafting and game element source generation for an electronic game, the method comprising:
receiving, by a device, at least one seed element, the at least one seed element received from a user as input for generation of a crafted element for an electronic game;
controlling, by the device, a machine model to generate at least one source element iteration for the crafted element, wherein the source element iteration provides at least one output for rendering the crafted element of the electronic game;
determining, by the device, at least one additional seed element for the crafted element;
controlling, by the device, a machine model to update the at least one source element iteration to include a second iteration; and
outputting, by the device, the crafted element to include the at least one source element.

2. The method of claim 1, wherein the seed element includes at least one of text, audio, graphical, video and user input, and wherein the seed element is received by the device and wherein the at least one seed element is received with an annotation providing an instruction for use of the at least one seed element for the crafted element.

3. The method of claim 1, wherein the seed element is input to first layer of a plurality of source code layers for rendering the crafted element.

4. The method of claim 1, wherein the iteration is generated based on a combination of seed elements from at least one user.

5. The method of claim 1, wherein the at least one additional seed element is determined to adjust at least one additional rendering level for the crafted element.

6. The method of claim 1, wherein controlling the machine model to update the at least one source element includes updating the source element iteration for at least one of a rendering structure, rendering appearance and rendering function using the second iteration.

7. The method of claim 1, wherein controlling the machine model to update the at least one source element includes tracking iterations and users associated with each iteration to the crafted element.

8. The method of claim 1, wherein controlling the machine model to update the at least one source element includes using a seed to update a plurality of rendering layers of the crafted element.

9. The method of claim 1, wherein output of the crafted element includes outputting source code for the crafted element, the source code configured for the electronic game and presentation of the crafted element during game play.

10. The method of claim 1, wherein controlling the machine model includes configuring the appearance of the crafted element followed by at least one of a structural and functional configuration of the crafted element.

11. A device configured for generative content crafting and game element source generation, the device comprising:
an interface;
a memory storing executable instructions; and
a processor coupled to the interface and the memory, wherein the controller is configured to
receive at least one seed element, the at least one seed element received from a user as input for generation of a crafted element for an electronic game;
control a machine model to generate at least one source element iteration for the crafted element, wherein the source element iteration provides at least one output for rendering the crafted element of the electronic game;
determine at least one additional seed element for the crafted element;
control a machine model to update the at least one source element iteration to include a second iteration; and
output the crafted element to include the at least one source element.

12. The device of claim 11, wherein the seed element includes at least one of text, audio, graphical, video and user input, and wherein the seed element is received by the device and wherein the at least one seed element is received with an annotation providing an instruction for use of the at least one seed element for the crafted element.

13. The device of claim 11, wherein the seed element is input to first layer of a plurality of source code layers for rendering the crafted element.

14. The device of claim 11, wherein the iteration is generated based on a combination of seed elements from at least one user.

15. The device of claim 11, wherein the at least one additional seed element is determined to adjust at least one additional rendering level for the crafted element.

16. The device of claim 11, wherein controlling the machine model to update the at least one source element includes updating the source element iteration for at least one of a rendering structure, rendering appearance and rendering function using the second iteration.

17. The device of claim 11, wherein controlling the machine model to update the at least one source element includes tracking iterations and users associated with each iteration to the crafted element.

18. The device of claim 11, wherein controlling the machine model to update the at least one source element includes using a seed to update a plurality of rendering layers of the crafted element.

19. The device of claim 11, wherein output of the crafted element includes outputting source code for the crafted element, the source code configured for the electronic game and presentation of the crafted element during game play.

20. The device of claim 11, wherein controlling the machine model includes configuring the appearance of the crafted element followed by at least one of a structural and functional configuration of the crafted element.
